(19) United States
(12) Patent Application Publication
(10) Pub. No.: US 2025/0362447 A1
(43) Pub. Date: Nov. 27, 2025

(54) OPTICAL FIBER END FACE REFRACTIVE INDEX MATCHING LAYER

(71) Applicant: CORNING RESEARCH & DEVELOPMENT CORPORATION, Corning, NY (US)

(72) Inventors: Jianwei Liu, Painted Post, NY (US); Kevin Robert McCarthy, Horseheads, NY (US); Randy LaRue McClure, Corning, NY (US); Qi Wu, Painted Post, NY (US)

(21) Appl. No.: 18/673,390

(22) Filed: May 24, 2024

(51) Int. Cl. G02B 6/02; C03C 25/20; C03C 25/32

(52) U.S. Cl. CPC G02B 6/02395; C03C 25/20; C03C 25/32

(57) ABSTRACT

A liquid polymer is deposited onto the end face of an optical fiber and cured to form a matching layer having an outer surface that faces away from the end face. During the curing process, the optical fiber may be oriented so the end face faces downward to produce a matching layer having a curved outer surface, or oriented so the end face faces upward to produce a matching layer having a flat outer surface. The end face may include a peripheral area formed from an easy-to-clean coating that confines the liquid polymer to the core and cladding areas of the end face. The easy-to-clean coating also prevents spillover of the liquid polymer onto the cladding of the optical fiber. Matching layer thickness may be tuned using a spin coating process.

### TECHNICAL FIELD

This disclosure relates generally to optical connectivity, and more particularly to optical fiber end face coatings.

### BACKGROUND

Optical fibers are useful in a wide variety of applications, including the telecommunications industry for voice, video, and data transmissions. Benefits of optical fibers include wide bandwidth and low noise operation. In a telecommunications system that uses optical fibers, there are typically many locations where fiber optic cables containing the optical fibers connect to equipment or other fiber optic cables. To conveniently provide these connections, fiber optic connectors are often provided on the ends of fiber optic cables to non-permanently connect and disconnect optical elements in the fiber optic network.

The introduction of fiber optic connectors, however, has the potential of also introducing insertion losses across the optical connection, e.g., at the junction between the connected optical fibers. One common optical connection in a network is one between two mated fiber optic connectors, such as within an adapter. It should be recognized, however, that the term “optical connection” may encompass other types of junctions between optical fibers. The insertion losses in coupling two optical fibers across an optical connection are a function of several factors. One of these factors can be the amount of light lost due to Fresnel reflections at the fiber end faces. Optical connections often leave a small air gap between the optical fiber end faces. This can lead to Fresnel reflections at each end face, with a resulting loss in signal across the optical connection.

One way of reducing Fresnel reflections is to introduce a refractive index matching fluid or gel into the optical connection. However, these materials complicate assembly and can cause adhesion and reliability problems.

Thus, there is a need in the fiber optic industry for improved methods and devices for reducing attenuation across fiber optic connections.

### SUMMARY

In one aspect of the disclosure, an improved article of manufacture is disclosed. The article includes a first optical fiber, a first easy to clean coating, and a first matching layer. The first optical fiber includes a first cladding having a first cladding outer surface, a first core surrounded by the first cladding, and a first end face having a first core area and a first cladding area. The first easy-to-clean coating is operatively coupled to the first cladding outer surface and defines a first peripheral area of the first end face. The first matching layer is operatively coupled to the first end face and includes a first matching layer outer surface that faces away from the first end face.

In one embodiment of the disclosed article, the first matching layer may be confined to the first core area and the first cladding area of the first end face. In one embodiment, the first matching layer outer surface may be dome-shaped. In another embodiment, the first matching layer outer surface may be generally flat.

In one embodiment of the disclosed article, the first matching layer may be formed by depositing a liquid polymer material on the first end face and curing the liquid polymer material while the liquid polymer material is on the first end face, and the first easy-to-clean coating may include a material with which the liquid polymer material has a higher contact angle than it has with either of the first core area or the first cladding area of the first end face.

In one embodiment of the disclosed article, the article may further include a second optical fiber having a second cladding, a second core surrounded by the cladding, and a second end face in contact with the first matching layer outer surface. In one embodiment, the first matching layer outer surface may include an apex, and the apex of the first matching layer outer surface may be in contact with the second end face. In another embodiment, the second end face may include a second core area, and the apex of the first matching layer outer surface may be in contact with the second core area of the second end face. In one embodiment, one or both of the first end face and the second end face may be unpolished.

In one embodiment of the disclosed article, a second matching layer may be operatively coupled to the second end face, the second matching layer may include a second matching layer outer surface that faces away from the second end face, and the first matching layer outer surface may be in contact with the second matching layer outer surface. In one embodiment, the article may further include a second easy-to-clean coating operatively coupled to the second matching layer outer surface. In one embodiment, the article may further include a third easy-to-clean coating operatively coupled to the first matching layer outer surface.

In another aspect of the disclosure, an improved method is disclosed. The method includes depositing a liquid polymer onto an end face of an optical fiber to form a self-supporting layer of the liquid polymer. The optical fiber includes a cladding and a core surrounded by the cladding, and the end face includes a core area and a cladding area. The method further includes curing the liquid polymer so that the liquid polymer hardens to form a matching layer having a matching layer outer surface that faces away from the end face.

In one embodiment of the disclosed method, depositing the liquid polymer onto the end face of the optical fiber may include depositing the liquid polymer onto a platter, spinning the platter to produce a layer of liquid polymer having a predetermined thickness, and bringing the end face of the of the optical fiber into contact with the layer of liquid polymer. In one embodiment, the platter may include a surface having a contact angle with the liquid polymer that is higher than the contact angle between the liquid polymer and at least one of the cladding area and the core area of the optical fiber end face.

In one embodiment of the disclosed method, the cladding may include a cladding outer surface. In this embodiment, the method may further include, prior to depositing the liquid polymer on the end face of the optical fiber, coating an end of the optical fiber with an easy-to-clean coating so that the easy-to-clean coating covers at least a portion of the cladding outer surface, and cleaving off an end portion of the optical fiber to define the end face so that the end face includes a peripheral area defined by a cross-sectional surface of the easy-to-clean coating. The easy-to-clean coating may include a material with which the liquid polymer material has a higher contact angle than it has with either of the core area or the cladding area of the end face.

In one embodiment of the disclosed method, the method may further include orienting the optical fiber so that the end face is facing in a downward direction while the liquid polymer is cured. In this embodiment, the downward orientation of the optical fiber may be such that gravity contributes to the liquid polymer having a dome shape while the liquid polymer is cured. In an alternative embodiment, the method may further include orienting the optical fiber so that the end face is facing in an upward direction while the liquid polymer is cured. In this embodiment, the upward orientation of the optical fiber may be such that gravity contributes to the liquid polymer having a generally flat shape while the liquid polymer is cured.

In one embodiment of the disclosed method, the curing step may include exposing the liquid polymer to ultraviolet light.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional diagrammatic view of an exemplary fiber optic connection between optical fibers including matching layers with flat outer surfaces.

FIG. 2 is a cross-sectional diagrammatic view of an exemplary fiber optic connection between optical fibers including matching layers with curved outer surfaces.

FIG. 3 is a cross-sectional diagrammatic view of an exemplary fiber optic connection between an optical fiber including a matching layer with a flat outer surface and an optical fiber without a matching layer.

FIG. 4 is a cross-sectional diagrammatic view of an exemplary fiber optic connection between an optical fiber including a matching layer with a curved outer surface and an optical fiber without a matching layer.

FIG. 5 is a diagrammatic view of a process that may be used to fabricate the optical fibers of FIGS. 1 and 3 with the matching layer having the flat outer surface.

FIG. 6 is a diagrammatic view of a process that may be used to fabricate the optical fibers of FIGS. 2 and 4 with the matching layer having the curved outer surface.

FIGS. 7 and 8 are micrographic views of an optical fiber at different stages of the fabrication process of FIG. 5.

FIGS. 9 and 10 are micrographic views of an optical fiber at different stages of the fabrication process of FIG. 6.

FIG. 11 is a schematic view of an apparatus including a spin coater for depositing a predetermined amount of matching layer material on the end face of an optical fiber.

FIG. 12 is a graphical view showing the thickness of the layer of matching layer material versus spin speed of the spin coater of FIG. 11.

FIG. 13 is a graphical view showing the contact angle between water and an easy-to-clean coating that may be deposited on the optical fibers by the processes of FIGS. 5 and 6.

FIG. 14 is a graphical view showing the contact angle between n-hexadecane and the easy-to-clean coating that may be deposited on the optical fibers by the processes of FIGS. 5 and 6.

### DETAILED DESCRIPTION

Various embodiments will be further clarified by examples in the description below. In general, the description relates to methods of adding a refractive index matching layer to an end face of an optical fiber. Embodiments include one or more of an easy-to-clean (ETC) coating operatively coupled to an outer surface of the optical fiber, and either a flat matching layer or a self-centering dome-shaped matching layer operatively coupled to the end face of the optical fiber. The resulting structure facilitates low loss optical coupling between optical fibers without the use of refractive index matching gels.

The matching layer may be fabricated by depositing a curable refractive index matching polymer (e.g., a UV curable polymer) on the end face of an optical fiber. The shape of the polymer may be tuned by controlling the curing process. The ETC coating on the outer surface of the optical fiber may help confine the refractive index matching polymer to the end face of the optical fiber, and prevent spillover onto the outer surface of the optical fiber. The resulting matching layer may have a curved outer surface that reduces or eliminates the air gap between two connecting optical fibers, resulting in low attenuation and simplifying field installation processes.

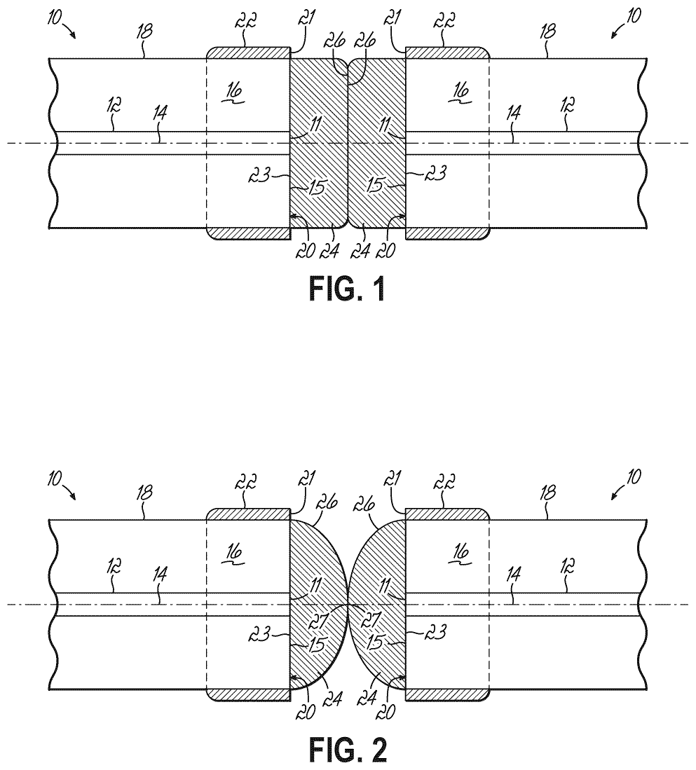

FIGS. 1 and 2 depict cross-sectional lengthwise views of exemplary optical fibers 10. Each optical fiber 10 includes a core 12 having a center axis 14, a cladding 16 surrounding the core 12 and having an outer surface 18, an end face 20, and an ETC coating 22 operatively coupled to a portion of the outer surface 18 adjacent to the end face 20. The core 12 and cladding 16 may be made of fused silica doped to have different indexes of refraction, although other materials/structures can also be used, such as polymers, voids (for a hollow core optical fiber), etc. The core 12 and cladding 16 of optical fiber 10 may thereby work cooperatively to define an optical waveguide that generally confines optical signals propagating through the optical fiber 10 to a region of the optical fiber 10 within and immediately adjacent to the core 12.

The end face 20 of each optical fiber 10 may include a core area 11 corresponding to the cross-sectional surface of core 12, a cladding area 15 corresponding to the cross-sectional surface of cladding 16, and a peripheral area 21 corresponding to the cross-sectional surface of ETC coating 22. The core area 11 and cladding area 15 of end face 20 are operatively coupled to (e.g., in contact with) an inner surface 23 of matching layer 24.

The matching layer 24 depicted by FIG. 1 has a generally flat outer surface 26, and the matching layer 24 depicted by FIG. 2 has a generally curved outer surface 26. Curved matching layer outer surfaces 26 may resemble a rotated conic section (e.g., a sphere or ellipse), or otherwise be generally dome-shaped. The point of the dome-shaped matching-layer outer surface 26 furthest from the end face 20 may be referred to as the apex 27 of the matching layer outer surface 26. Matching layers 24 having curved outer surfaces 26 may be configured so that the apex 27 of the matching layer outer surface 26 is proximate to (e.g., aligned with) the center axis 14 of core 12.

To efficiently transmit optical signals between the connected optical fibers 10, a physical contact connector should minimize coupling losses. These coupling losses may include losses due to Fresnel reflections at each fiber-to-air interface at the end faces 20 of the connected optical fibers 10. Other extrinsic factors that can cause losses across an optical connection may be related to the characteristics of the end faces 20 of optical fibers 10. For example, end faces 20 having a rough surface, an undercut, or a protrusion that remains after the cleaving and polishing process may suffer from coupling losses across the optical connection due to poor mating between end faces 20.

FIG. 1 depicts an exemplary optical connection between optical fibers 10 having matching layers 24 with flat outer surfaces 26. FIG. 2 depicts an exemplary optical connection between optical fibers 10 having matching layers 24 with dome-shaped outer surfaces 26. The dome-shaped outer surface 26 depicted by FIG. 2 may prevent air from being trapped between the outer surfaces 26 when the optical fibers 10 are pushed into place, particularly in contact areas proximate to the center axes 14 of cores 12. Additional advantages of the matching layers 24 include providing a buffer layer for a soft connection (e.g., that avoids damaging the end faces 20), improved optical coupling to unpolished end faces 20 (e.g., that allows elimination of polishing steps after cleaving the optical fiber 10 for low cost connectors), and the ability to tune the thickness of the matching layer 24 to accommodate connector requirements.

As used in this disclosure, the term “ETC coating” refers to a coating that has a lower degree of wetting with the refractive index matching polymer (in its liquid state prior to curing) than the core area 11 and cladding area 15 of optical fiber end face 20. Wetting in this context thus refers to the ability of the uncured refractive index matching polymer to maintain contact with the solid surfaces of the core area 11, cladding area 15, and peripheral area 21 of optical fiber end face 20. Wettability may be characterized by the contact angle between the liquid and solid in question. In this case, the contact angle is the angle at which the air-liquid interface of the refractive index matching polymer meets the solid-liquid interface of the refractive index matching polymer. The contact angle is an inverse measure of wettability, with higher contact angles indicating lower wettability.

Accordingly, the ETC coating 22 comprises a material having a contact angle with the liquid refractive index matching polymer that is greater than the contact angle between the liquid refractive index matching polymer and one or both of the core 12 and cladding 16 of optical fiber 10. Preferably, the contact angle with the ETC coating is at least 25% greater, more preferably at least 50% greater, and still more preferably at least 75% greater than the contact angle with the core 12 and cladding 16 of optical fiber 10.

The ETC coating 22 may include a material (e.g., a perfluoropolyether) that repels water, oils, ketones, hydrocarbons, etc. The ETC coating 22 may be applied by providing one or more liquid solutions to the end of the optical fiber 10 being coated, e.g., by dipping, flowing, spraying, or any other suitable methods of application. These liquid solutions may be prepared shortly before application, and include one or more fluorine-containing silane compounds, hydrolysable compounds, polysiloxane compounds, large-sized ceramic particles, nano-sized ceramic particles, and solvents. The ETC coating 22 may be formed by the reaction products of the applied solutions being deposited on the optical fiber 10. The ETC coating 22 may minimize contamination of the cladding outer surface 18 as well as prevent spillover of the matching layer material onto the cladding outer surface 18. Avoiding unwanted deposition of the matching layer material onto the cladding outer surface 18 may improve fiber lateral alignment. An ETC coating (not shown) may also be applied to the matching layer outer surface 26 to prevent contamination thereof.

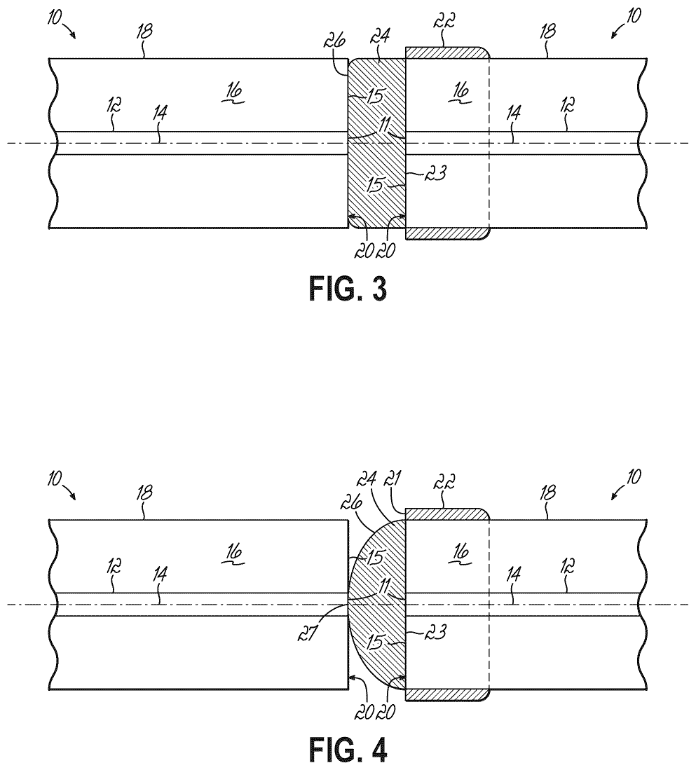

FIGS. 3 and 4 depict cross-sectional lengthwise views of exemplary optical fibers 10 for an optical connection in which only one of the two mated optical fibers 10 includes the ETC coating 22 and matching layer 24. FIGS. 3 and 4 demonstrate that optical fibers 10 having the ETC coating 22 and matching layer 24 can be connected to (and improve the performance of) optical fibers 10 lacking these features, and may therefore be used with legacy optical fiber installations or field terminated fibers.

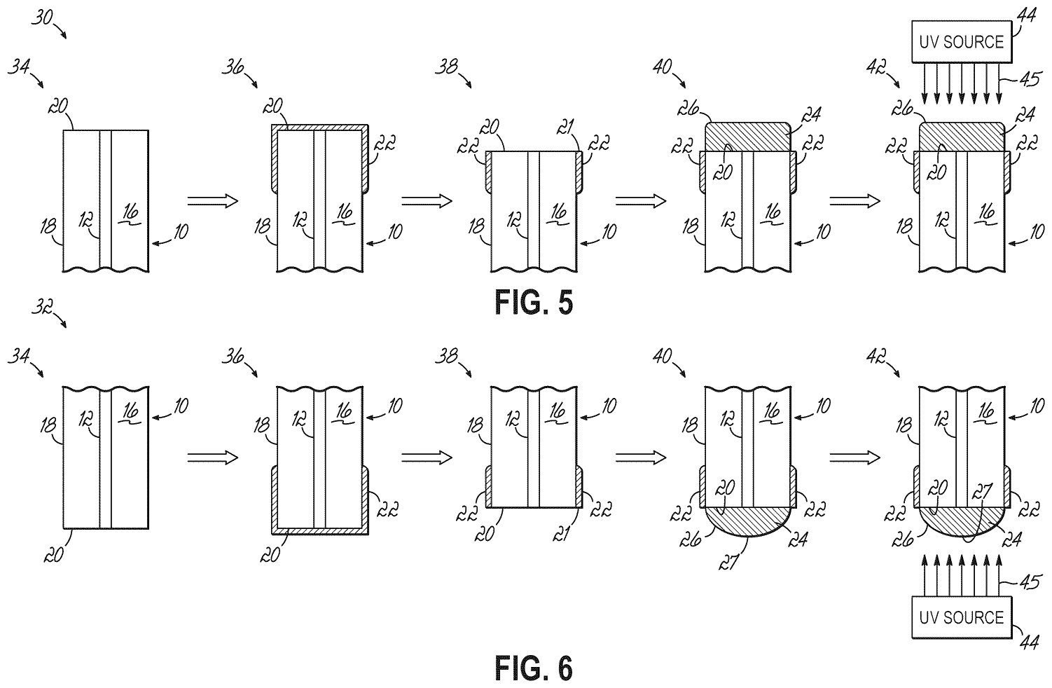

FIGS. 5 and 6 depict exemplary processes 30, 32 for fabricating a flat matching layer 24 (FIG. 5) and a dome-shaped matching layer 24 (FIG. 6). In each process 30, 32, an optical fiber 10 including an end face 20 is provided at step 34. At step 36 of each process 30, 32, an ETC coating 22 is applied to the optical fiber 10. The ETC coating 22 covers the end face 20 and the outer surface 18 of cladding 16 proximate to the end face 20. The ETC coating 22 may be applied, for example, by exposing the end of the optical fiber 10 in question to one or more liquid solutions as described above. At step 38 of each process 30, 32, the optical fiber 10 is cleaved to expose a new end face 20. The cleave may be positioned along the optical fiber 10 at a distance from the initial end face 20 so that a remaining portion of the ETC coating 22 defines the peripheral area 21 adjacent to the cladding area 15 of end face 20.

At step 40, a predetermined amount of liquid matching layer material (e.g., a UV curable polymer) is applied to the end face 20 of optical fiber 10. The end face 20 of optical fiber 10 may be unpolished when the liquid matching layer material is applied, thereby eliminating a typical fabrication step. The amount of liquid matching layer material applied may be predetermined based on the desired thickness and shape of the matching layer 24. To this end, the predetermined amount of liquid matching layer material may be selected such that the resulting liquid matching layer 24 is self-supporting. The liquid matching layer 24 is considered as self-supporting when the combined effects of all the forces acting on the liquid matching layer 24 (e.g., the adhesive forces between the liquid matching layer 24 and the end face 20 of optical fiber 10, the cohesive forces within the liquid matching layer 24, and gravity) operate collectively to form the liquid matching layer 24 into the desired thickness and shape without the use of any external structure other than the optical fiber 10 itself. At step 42, the matching layer material is cured, e.g., by activating a UV source 44 and exposing the matching layer 24 to UV light 45. Curing the matching layer material causes the matching layer 24 to harden, thereby permanently setting the shape thereof.

The processes 30, 32 may differ from one another at steps 40 and 42 in that the end face 20 of optical fiber 10 may be facing upward in process 30 and downward in process 32. The force of gravity acting on the uncured matching layer material in process 30 may result in the matching layer 24 having a relatively flat outer surface 26, and the UV source 44 may be generally positioned above the end face 20 so that UV light 45 shines down onto the matching layer 24. The force of gravity acting on the uncured matching layer material in process 32 may result in the matching layer 24 having a generally curved (e.g., spherical) outer surface 26, and the UV source 44 may be positioned below the end face 20 so that the UV light shines upward onto the matching layer material.

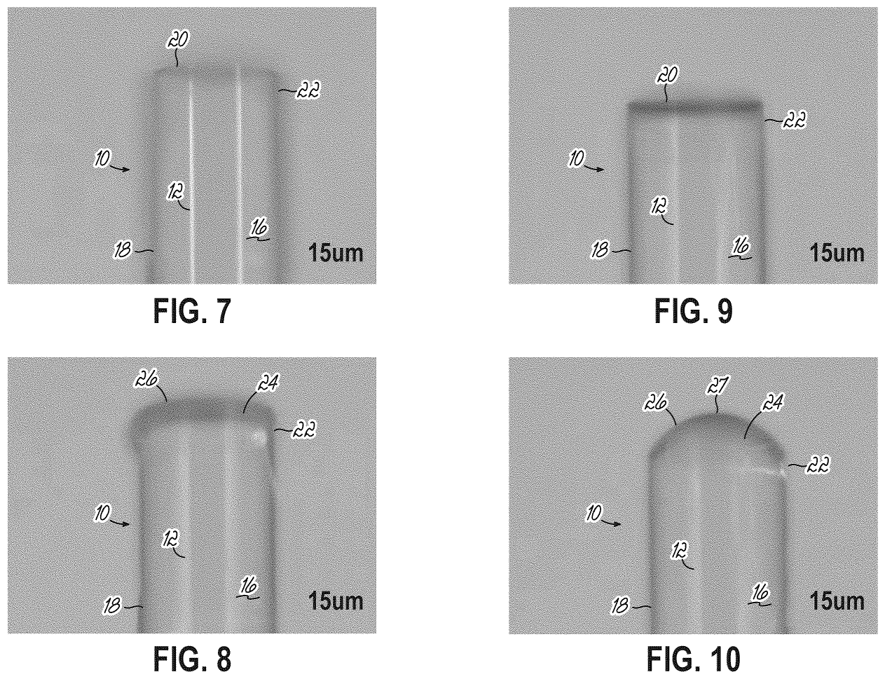

FIGS. 7 and 9 depict micrographs of respective optical fibers 10 at step 38, and FIGS. 8 and 10 depict micrographs of the optical fibers of FIGS. 7 and 9 at step 42, respectively. The optical fiber 10 depicted by FIGS. 7 and 8 was produced using a process consistent with process 30, and has a matching layer 24 with a flat matching layer outer surface 26. The optical fiber 10 depicted by FIGS. 9 and 10 was produced using a process consistent with process 32, and has a matching layer 24 with a curved matching layer outer surface 26.

As shown by FIGS. 7 and 9, the ETC coating 22 on the cladding outer surface 18 has a smooth surface after cleaving. FIG. 8 shows that a flat matching layer outer surface 26 can be formed by curing the matching layer material with the end face 20 of optical fiber 10 facing upward. The matching layer 24 depicted by FIG. 8 also has a noticeable overhang, which could cause alignment issues if left untreated. FIG. 10 shows a dome-shaped matching layer outer surface 26 can be formed by curing the matching layer material with the end face 20 of optical fiber 10 facing downward. In the downward facing case, the force of gravity may also tend to align the apex 27 of the dome-shaped matching layer outer surface 26 with the center axis 14 of core 16.

The thickness of the matching layer 24 can have a significant effect on its optical performance. However, controlling the thickness and location of the matching layer 24 on the end face 20 of optical fiber 10 during fabrication may be challenging due to the size of the core 12, which typically has a diameter of between 8 μm and 10.5 μm in single mode fibers. One way to address this problem is to use a spin coating technique that tunes the thickness of the matching layer material prior to deposition on the end face 20 of optical fiber 10.

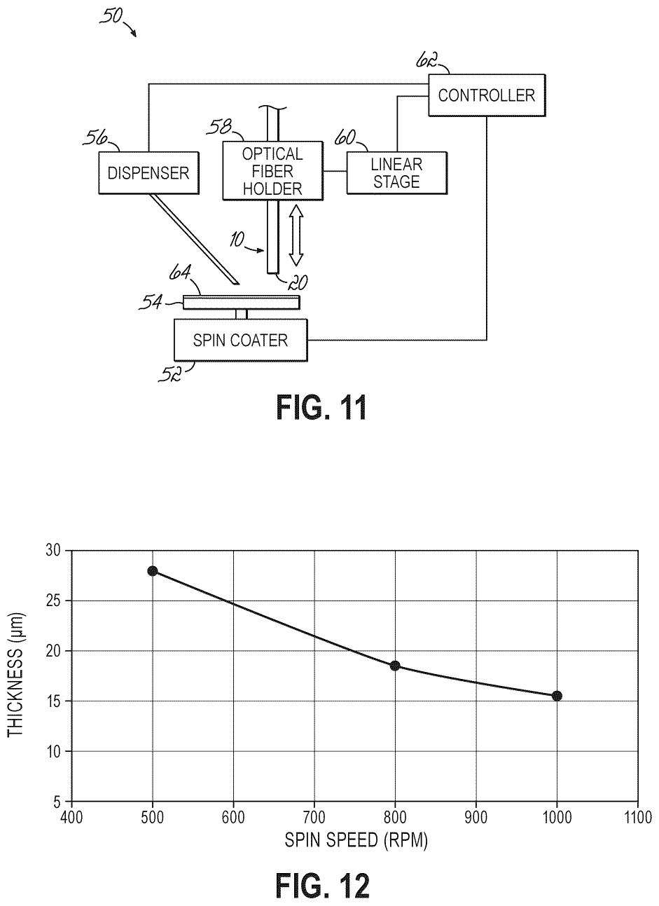

FIG. 11 depicts an exemplary apparatus 50 for controlling the thickness of the matching layer 24 using spin coating. The apparatus 50 includes a spin coater 52 having a platter 54, a dispenser 56 configured to dispense matching layer material onto the platter 54, an optical fiber holder 58 configured to hold one or more optical fibers 10, a linear stage 60 configured to move the optical fiber holder 58 relative to the platter 54 of spin coater 52, and a controller 62 in communication with the spin coater 52, dispenser 56, and linear stage 60.

The thickness of the layer of material dispensed onto the platter 54 of spin coater 52 may be controlled by adjusting the rate at which the platter 54 is rotated. The relation between thickness and spin speed may be generally predicted by:

$${h}_{f} ∝ \frac{1}{\sqrt{ω}}$$

where ω is the spin speed and hᵣ is the final film thickness. FIG. 12 depicts a graph showing the measured layer thickness versus spin speed for one exemplary matching layer material.

In operation, matching layer material 64 may be dispensed onto the platter 54 of spin coater 52 by the dispenser 56. The dispensing operation may occur while the platter 54 is spinning at a rate that has been previously determined to provide a desired matching layer thickness. The spin coater 52 may then bring the platter 54 to a halt, and the linear stage 60 activated to bring the end face 20 of optical fiber 10 into contact with the matching layer material 64. The matching layer material 64 may then adhere to the core and cladding areas 11, 15 of optical fiber end face 20. When the optical fiber 10 is pulled away from the platter 54, a volume of matching layer material 64 having a diameter approximately equal to that of the optical fiber 10 and a height approximately equal to the thickness of the spin-coated layer may separate from the platter 54 and remain attached to the end face 20 of optical fiber 10. To promote the transfer of matching layer material 64 from the platter 54 to the end face 20 of optical fiber 10, the upper surface of platter 54 may be configured to have a contact angle with the matching layer material 64 that is larger than the contact angle between the matching layer material 64 and the core and cladding areas 11, 15 of optical fiber end face 20.

The thickness, morphology, and shape of the matching layer 24 may be tuned by controlling the spin rate, optical fiber orientation, and UV exposure direction. Advantageously, the use of a dome-shaped matching layer 24 on the end face 20 of optical fiber 10 may prevent air from being trapped proximate to the center axis 14 of core 12. The end face peripheral area 21 provided by the ETC coating 22 on the outer surface 18 of cladding 16 may repel the uncured matching layer material. The use of spin coating to control thickness may enable features described below that are distinct from other approaches.

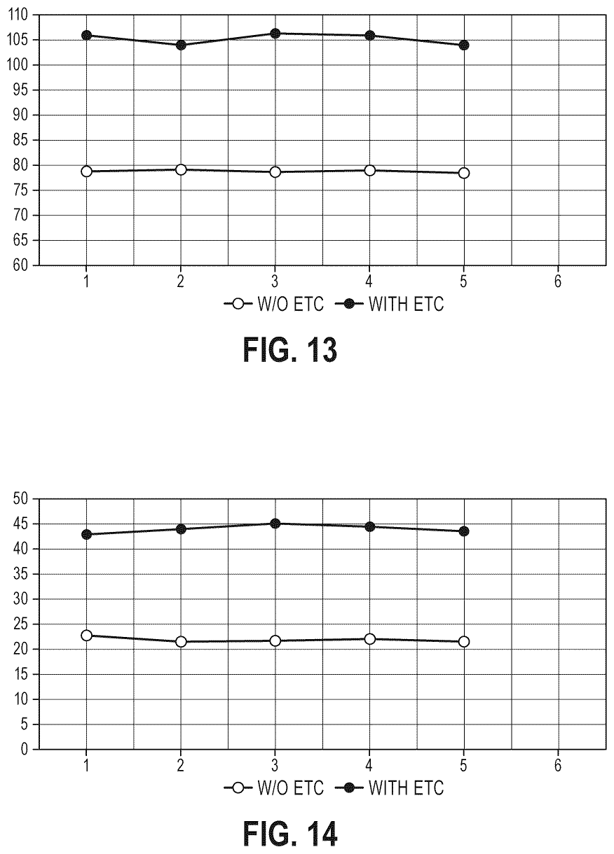

The ETC coating 22 may be selected so that it repels the uncured matching layer material 64. As a result, the peripheral area 21 of end face 20 provided by the ETC coating 22 may prevent the matching layer material 64 from adhering to the sides of the optical fiber 10. The peripheral area 21 of optical fiber end face 20 may also confine the matching layer material 64 to the core area 11 and cladding area 15 of end face 20. Examples of the effectiveness of ETC coatings 22 at repelling water and n-hexadecane are provided by FIGS. 13 and 14. The depicted graphs show contact angle data for five sample surfaces with and without ETC coatings. After ETC coating, the average water contact angle increases from 78.77 to 105.26 degrees (FIG. 13) and the average n-hexadecane contact angle increases from 22.38 to 44.36 degrees (FIG. 14).

Suitable matching layer materials 64 may include UV curable acrylate coatings. Testing was performed using samples of UV cured acrylate 119-3 on 2319 glass substrates. The acrylate was smoothly applied to the substrate to form a layer thick enough to act as a bulk substrate. Testing was also performed on bulk samples of uncured acrylate.

Relative index of refraction measurements were performed using a Metricon Model 2010 Prism Coupler (available from the Metricon Corporation of Pennington, New Jersey, United States) and laser sources at a wavelength of 1308 nm. The Metricon 2010 prism coupler operates as a fully automated refractometer that measures the refractive index of bulk materials or films.

If a material with an index of refraction n is coupled to a prism with an index of refraction nₚ, laser light directed onto the base of the prism will be totally reflected until the angle of incidence q becomes less than the critical angle q_{c}, where:

q_{c}=arcsin(n/nₚ)

The critical angle q_{c} can be measured using a photodetector because the intensity on the detector drops abruptly as the angle of incidence q drops below the critical angle q_{c}. Since the refractive index nₚ of the prism is known, the refractive index n of the material can be determined from the above equation. Tables I-V show the results of refractive index measurements on the acrylate samples as well as selected glass samples. As can be seen, the measured refractive indices are very close to that of silica based optical fibers.

TABLE I
Cured Resin on Glass - Air Resin Interface

| Sample | λ (nm) | n | Avg. | Corrected Avg. |
|---|---|---|---|---|
| 1 | 1308 | 1.4588 | NA | NA |
| 2 | 1308 | 1.4588 | NA | NA |
| 3 | 1308 | 1.4587 | NA | NA |
| | | | 1.4588 | 1.4589 |

TABLE II
Cured Resin on Glass - Resin-Glass Interface

| Sample | λ (nm) | n | Avg. | Corrected Avg. |
|---|---|---|---|---|
| 1 | 1308 | 1.4587 | NA | NA |
| 2 | 1308 | 1.4585 | NA | NA |
| 3 | 1308 | 1.4585 | NA | NA |
| | | | 1.4586 | 1.4587 |

TABLE III
Liquid Resin

| Sample | λ (nm) | n | Avg. | Corrected Avg. |
|---|---|---|---|---|
| 1 | 1308 | 1.4378 | NA | NA |
| 2 | 1308 | 1.4375 | NA | NA |
| 3 | 1308 | 1.4378 | NA | NA |
| | | | 1.4377 | 1.4378 |

TABLE IV
Cover Slip

| Sample | λ (nm) | n | Avg. | Corrected Avg. |
|---|---|---|---|---|
| 1 | 1308 | 1.5153 | NA | NA |
| 2 | 1308 | 1.5154 | NA | NA |
| | | | 1.5154 | 1.5155 |

TABLE V
2319 Glass

| Sample | λ (nm) | n | Avg. | Corrected Avg. |
|---|---|---|---|---|
| 1 | 1308 | 1.4827 | NA | NA |
| 2 | 1308 | 1.4871 | NA | NA |
| | | | 1.4871 | 1.4871 |

The tensile strength and Young's modulus of the cured acrylate are 0.33 MPa and 0.47 MPa, respectively. As can be seen from Table VI, these values are less than those of the primary coating of optical fibers. Thus, the relatively soft matching layer may serve as a buffer layer for optical fiber connections. In particular, the matching layer may advantageously fill gaps between fiber arrays having a cleave angle.

TABLE VI
Mechanical Properties of Materials

| | Tensile | | | | Young's | |
|---|---|---|---|---|---|---|
| | Strength | St. | | St. | Modulus | St. |
| Material | (MPa) | Dev. | % Elong. | Dev. | (MPa) | Dev. |
| Cured | 0.33 | 0.05 | 111.49 | 12.11 | 0.47 | 0.06 |
| Acrylate | | | | | | |
| Fiber | 0.88 | 0.1 | 191.72 | 18.69 | 0.65 | 0.03 |
| Primary | | | | | | |
| Coating | | | | | | |
| 74-2 | | | | | | |
| Typ. | 0.52 | 0.07 | 146.5 | 20 | 0.72 | 0.02 |
| Primary | | | | | | |
| Coating | | | | | | |

Optical attenuation was measured on mechanical splices formed using a Corning CamSplice Mechanical Splice Assembly Fixture (available from Corning Inc. of Corning, New York, United States). The splices were between a non-coated cleaved fiber and coated fibers with matching layers having flat outer surfaces and dome-shaped outer surfaces. The insertion loss and return loss values measured for these splices are listed in Table VII.

TABLE VII
Insertion and Return Losses of Splices

| λ (nm) | Matching Layer Type | Insertion Loss (dB) | Return Loss (dB) |
|---|---|---|---|
| 1550 | flat | 0.80 | 53.19 |
| 1310 | flat | 0.64 | 52.86 |
| 1550 | curved | 0.07 | 56.50 |
| 1310 | curved | 0.23 | 55.42 |

As can be seen from the results listed in Table VII, the flat matching layers had an insertion loss of 0.80 dB at 1550 nm and 0.64 dB at 1310 nm. These values are higher than the standard 0.3 dB maximum insertion loss requirement for splices. Return loss at both wavelengths is greater than 50 dB. The higher insertion losses measured for the flat matching layers relative to the dome-shaped matching layers may have been due to air being trapped between the matching layer outer surface of the treated optical fiber and the end face of the untreated optical fiber. The higher insertion losses may also be attributed to the polymer coating extending radially beyond the cladding outer surface of optical fiber, thereby causing lateral offsets between the optical fibers on each side of the splice.

In contrast, the matching layers with dome-shaped outer surfaces had insertion losses of 0.07 dB at 1550 nm and 0.23 dB at 1310 nm, which are within the standard 0.3 dB maximum insertion loss requirement. Matching layers with dome-shaped outer surfaces also demonstrated improved return losses as compared to those having flat matching layer outer surfaces. This improved performance may be indicative of a closer physical connection due to the dome-shaped matching layer outer surface having improved contact with the end face of the opposing optical fiber as compared to the flat matching layer outer surface.

Advantageously, adding a matching layer to the end face of an optical fiber improves the performance of mechanical splices. This improvement is particularly evident with dome-shaped matching layers. Depositing an ETC coating on the cladding outer surface may also improve both the insertion loss and return loss performance of connections between optical fibers. The use of matching layers may also allow optical fibers to be connected without polishing the end faces after cleaving, thereby reducing fabrication costs. Embodiments disclosed herein may be applied to both single and multiple fiber connectors for factory or field termination processes.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

1. An article of manufacture, comprising:
a first optical fiber including a first cladding having a first cladding outer surface, a first core surrounded by the first cladding, and a first end face having a first core area and a first cladding area;
a first easy-to-clean coating operatively coupled to the first cladding outer surface and defining a first peripheral area of the first end face; and
a first matching layer operatively coupled to the first end face and including a first matching layer outer surface that faces away from the first end face.

2. The article of claim 1, wherein the first matching layer is confined to the first core area and the first cladding area of the first end face.

3. The article of claim 1, wherein:
the first matching layer is formed by depositing a liquid polymer material on the first end face and curing the liquid polymer material while the liquid polymer material is on the first end face, and
the first easy-to-clean coating includes a material with which the liquid polymer material has a higher contact angle than the liquid polymer material has with either of the first core area or the first cladding area of the first end face.

4. The article of claim 1, wherein the first matching layer outer surface is dome-shaped.

5. The article of claim 1, further comprising:
a second optical fiber including a second cladding, a second core surrounded by the cladding, and a second end face in contact with the first matching layer outer surface.

6. The article of claim 5, wherein the first matching layer outer surface includes an apex, and the apex of the first matching layer outer surface is in contact with the second end face.

7. The article of claim 6, wherein the second end face includes a second core area, and the apex of the first matching layer outer surface is in contact with the second core area of the second end face.

8. The article of claim 5, further comprising:
a second matching layer operatively coupled to the second end face and including a second matching layer outer surface that faces away from the second end face,
wherein the first matching layer outer surface is in contact with the second matching layer outer surface.

9. The article of claim 8, further comprising:
a second easy-to-clean coating operatively coupled to the second matching layer outer surface.

10. The article of claim 5, wherein the second end face is unpolished.

11. The article of claim 1, wherein the first end face is unpolished.

12. The article of claim 1, further comprising:
a third easy-to-clean coating operatively coupled to the first matching layer outer surface.

13. A method, comprising:
depositing a liquid polymer onto an end face of an optical fiber to form a self-supporting layer of the liquid polymer, the optical fiber including a cladding and a core surrounded by the cladding, the end face including a core area and a cladding area; and
curing the liquid polymer so that the liquid polymer hardens to form a matching layer having a matching layer outer surface that faces away from the end face.

14. The method of claim 13, wherein depositing the liquid polymer onto the end face of the optical fiber includes:
depositing the liquid polymer onto a platter;
spinning the platter to produce a layer of the liquid polymer having a predetermined thickness; and
bringing the end face of the of the optical fiber into contact with the layer of the liquid polymer.

15. The method of claim 14, wherein the platter includes a surface having a contact angle with the liquid polymer that is higher than the contact angle between the liquid polymer and at least one of the cladding area and the core area of the optical fiber.

16. The method of claim 13, wherein the cladding includes a cladding outer surface, and further comprising, prior to depositing the liquid polymer on the end face of the optical fiber:
coating an end of the optical fiber with an easy-to-clean coating so that the easy-to-clean coating covers at least a portion of the cladding outer surface; and
cleaving off an end portion of the optical fiber to define the end face so that the end face includes a peripheral area defined by a cross-sectional surface of the easy-to-clean coating,
wherein the easy-to-clean coating includes a material with which the liquid polymer material has a higher contact angle than the liquid polymer material has with either of the core area or the cladding area of the end face.

17. The method of claim 13, further comprising:
orienting the optical fiber so that the end face is facing in a downward direction while the liquid polymer is cured.

18. The method of claim 17, wherein the downward orientation of the optical fiber is such that gravity contributes to the liquid polymer having a dome shape while the liquid polymer is cured.

19. The method of claim 13, wherein the curing step includes:
exposing the liquid polymer to ultraviolet light.
